(19) United States
(12) Patent Application Publication
(10) Pub. No.: US 2025/0220188 A1
(43) Pub. Date: Jul. 3, 2025

(54) COMPRESSING BINARY MASK USING 2D RUN LENGTH ENCODING WITH CONTEXT

(71) Applicant: Nokia Technologies Oy, Espoo (FI)

(72) Inventors: Honglei ZHANG, Tampere (FI); Miska Matias HANNUKSELA, Tampere (FI)

(21) Appl. No.: 19/000,838

(22) Filed: Dec. 24, 2024

Related U.S. Application Data
(60) Provisional application No. 63/615,238, filed on Dec. 27, 2023.

(51) Int. Cl. H04N 19/13; H04N 19/157; H04N 19/182

(52) U.S. Cl. CPC H04N 19/13; H04N 19/157; H04N 19/182

(57) ABSTRACT

An apparatus including at least one processor, and at least one non-transitory memory storing instructions that, when executed with the at least one processor, cause the apparatus to perform: converting a mask into a list of numbers and at least one associated context; and encoding a plurality of the list of numbers using a context-based coding based upon the at least one associated context.

### TECHNICAL FIELD

The example and non-limiting embodiments relate generally to video coding and decoding and, more particularly, to video coding and decoding with context.

### BRIEF DESCRIPTION OF PRIOR DEVELOPMENTS

Video codec with use of a mask is known.

### SUMMARY OF THE INVENTION

The following summary is merely intended to be an example. The summary is not intended to limit the scope of the claims.

In accordance with one aspect, an example apparatus is provided comprising: at least one processor; and at least one non-transitory memory storing instructions that, when executed with the at least one processor, cause the apparatus to perform: converting a mask into a list of numbers and at least one associated context; and encoding a plurality of the list of numbers using a context-based coding based upon the at least one associated context.

In accordance with one aspect, an example method is provided comprising: converting a mask into a list of numbers and at least one associated context; and encoding a plurality of the list of numbers using a context-based coding based upon the at least one associated context.

In accordance with one aspect, an example apparatus is provided comprising: means for converting a mask into a list of numbers and at least one associated context; and means for encoding a plurality of the list of numbers using a context-based coding based upon the at least one associated context.

In accordance with one aspect, an example is provided with a non-transitory program storage device readable by an apparatus, tangibly embodying a program of instructions executable with the apparatus for performing operations, the operations comprising: converting a mask into a list of numbers and at least one associated context; and encoding a plurality of the list of numbers using a context-based coding based upon the at least one associated context.

In accordance with one aspect, an example apparatus is provided comprising: at least one processor; and at least one non-transitory memory storing instructions that, when executed with the at least one processor, cause the apparatus to perform: receiving an encoded signal; and decoding the encoded signal comprising: using an entropy encoder with an unsigned run length context to decode a first portion of the encoded signal, and using the entropy encoder with a signed relative position context to decode a different second portion of the encoded sign.

In accordance with one aspect, an example method is provided comprising: receiving an encoded signal; and decoding the encoded signal comprising: using an entropy encoder with an unsigned run length context to decode a first portion of the encoded signal, and using the entropy encoder with a signed relative position context to decode a different second portion of the encoded sign.

In accordance with one aspect, an example apparatus is provided comprising: means for receiving an encoded signal; and means for decoding the encoded signal comprising: using an entropy encoder with an unsigned run length context to decode a first portion of the encoded signal, and using the entropy encoder with a signed relative position context to decode a different second portion of the encoded sign.

In accordance with one aspect, an example is provided with a non-transitory program storage device readable by an apparatus, tangibly embodying a program of instructions executable with the apparatus for performing operations, the operations comprising: receiving an encoded signal; and decoding the encoded signal comprising: using an entropy encoder with an unsigned run length context to decode a first portion of the encoded signal, and using the entropy encoder with a signed relative position context to decode a different second portion of the encoded sign.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 is a block diagram of one possible and non-limiting example system in which an embodiment may be practiced;

FIG. 2 illustrates a block diagram of an example apparatus (a terminal device) used to implement one or more of the entities in FIG. 1;

FIG. 3 is an example of an input binary mask image;

FIG. 4 is a example of a current row and a previous row in a mask;

FIG. 5 is a diagram illustrating an example method; and

FIG. 6 is a diagram illustrating an example method.

### DETAILED DESCRIPTION

The following abbreviations that may be found in the specification and/or the drawing figures are defined as follows:
ANS asymmetric numeral system
CDV cumulative distribution vector
CTU coding tree unit
CU coding unit
ID identifier
NAL network abstraction layer
OOR out-of-range
QP quantization parameter
RLE run length encoding
RLEC run length encoding with context
ROI region of interest
SEI supplemental enhancement information
SRPC signed relative position context
URLC unsigned run length context
w.r.t with respect to

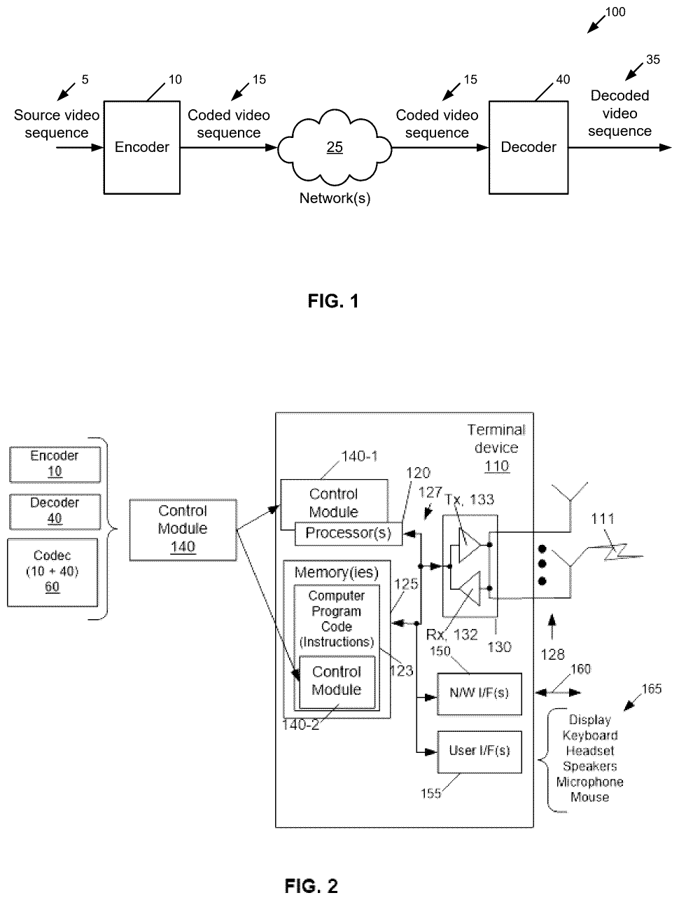

Turning to FIG. 1, this figure shows a block diagram of one possible and non-limiting example system 100 in which the example embodiments may be practiced. An encoder 10 analyzes a source video sequence 5 and produces a coded video sequence 15, which is communicated over a network 25 to a decoder 40. The decoder 40 analyzes the coded video sequence 15 and produces a reconstructed video sequence 35, which may be similar to the source video sequence 5.

The network 25 may be a singular network, such as a local area network for example. As other examples, the network 25 could include multiple networks, such as a local area network to get to the Internet, through the Internet to another local area network; a cellular network to another cellular network; or other combinations of networks.

The encoder 10 and decoder 40 may be implemented in many different apparatuses. Referring also to FIG. 2, this figure illustrates a block diagram of an exemplary apparatus (a terminal device 110 in this example) used to implement one or more of the entities in FIG. 1. The term “terminal device” is used since the example of FIG. 1 has a communication that terminates on both ends. The term terminal device is not meant to be limiting, and such a device can be any electronic device able to receive or transmit coded or uncoded video.

The terminal device 110 includes circuitry comprising one or more processors 120, one or more memories 125, one or more transceivers 130 (or receiver(s) and transmitter(s)), one or more network (N/W) interface(s) (I/Fs) 150, and one or more user I/F(s) 155 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128, which may communicate using wireless link 111 with other devices.

The one or more memories 125 include computer program code 123 (comprising instructions). The terminal device 110 includes a control module 140. The control module 140 may implement the encoder 10, the decoder 40, or a codec 60, which includes both an encoder 10 and a decoder 60.

The control module 140 comprises one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and (e.g., instructions in) the computer program code 123 may be configured to, in response to the one or more processors 120 executing the instructions, cause the user equipment 110 to perform one or more of the operations as described herein.

A wired network connection 160 may be used by the one or more network interfaces 150. The user interface(s) 155 may interface with user interface elements 165 such as, for example, a display, a keyboard, a headset (e.g., only earphones or earphones and microphone), speakers, a microphone, and/or mouse. Some of these can be internal, some can be internal, or there could be a combination of internal and external elements 165. For example, a smartphone as the terminal device 110 could have an internal display and internal speakers as elements 165, or a personal computer as the terminal device 110 could have a display, keyboard, mouse, and speakers that are external to the personal computer.

Having thus introduced one suitable but non-limiting technical context for the practice of example embodiments, example embodiments will be described with greater specificity below.

As noted with regard to FIG. 1, video codec generally consists of an encoder that transforms the input video into a compressed representation suited for storage and/or transmission, and a decoder that can decompress the compressed video representation back into a viewable form. Typically, an encoder discards some information in the original video sequence in order to represent the video in a more compact form; at lower bitrate.

Typical hybrid video codecs, for example ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding specifications may enable the use of supplemental enhancement information (SEI) messages or alike. Some video coding specifications include SEI NAL units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages, but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A design principle has been followed for SEI message specifications: the SEI messages are generally not extended in future amendments or versions of the standard.

### Image/Video Encoding Supporting Region of Interest

For an application where image/video coding is applied, some regions of the input frame may contain important information for the system, while other regions are less important. The regions that are important for the system may be referred to as regions of interest (ROI) or foreground regions. Regions other than the foreground regions may be referred to as non-ROI or background regions. Given the information of the ROIs as input, the encoder may encode the ROIs with higher qualities while encoding the non-ROIs with lower qualities.

In conventional image/video codecs, a frame may be partitioned into processing blocks, for example, coding tree unit (CTU) and coding unit (CU). The rate-distortion trade-off of each processing block may be controlled by parameters, such as the quantization parameter (QP). For processing units that fall into the ROI or overlap significantly with the ROI, encoding parameters that achieve high reconstruction quality may be applied.

For end-to-end learned neural network-based image/video codec, an input frame is processed in a non-block manner. For example, the whole input frame is transformed by a neural network encoder to generate a latent representation to be quantized and encoded into a bitstream by the entropy encoder using the distribution estimated by the probability model. Since the input frame is processed as a whole, an encoder may encode the regions in the latent representation with different quantization factor, for example, applying a scaling factor before the quantization. At the decoder side, an inverse operation may be applied to the regions that have been scaled. The ROI information may be signaled from the encoder to the decoder to indicate foreground and background regions.

The ROI information may be represented by a binary mask image/video where zero- value pixels indicate background region and one-value pixels indicate foreground regions, or vise-versa. Thus, effective compression methods are required to reduce the bitstream overhead caused by signaling the binary masks.

### Run Length Encoding and Entropy Encoding

Run length encoding (RLE) is a lossless coding technique where the repeated symbols are encoded by the symbol value and the times that the symbol is repeated. For example, the RLE of sequence “AAABBCCCC” may be “A3B2C4”.

Entropy coding is a lossless encoding technique where input symbols are encoded into a bitstream based on the probability distribution of the symbols. The expected bitstream length is close to the lower bound declared by Shannon's source coding theorem. Arithmetic coding and asymmetric numeral system (ANS) are two methods of entropy coding.

Binary marks may be compressed with an image/video codec optimized for natural image/video content. However, the performance of these codecs for binary masks is normally low compared to codecs specifically designed for this type of content.

Binary masks may also be encoded by encoding the coordinates of the detected ROI regions. Another method to encode the binary mask is to use RLE method to encode the pixels in the mask.

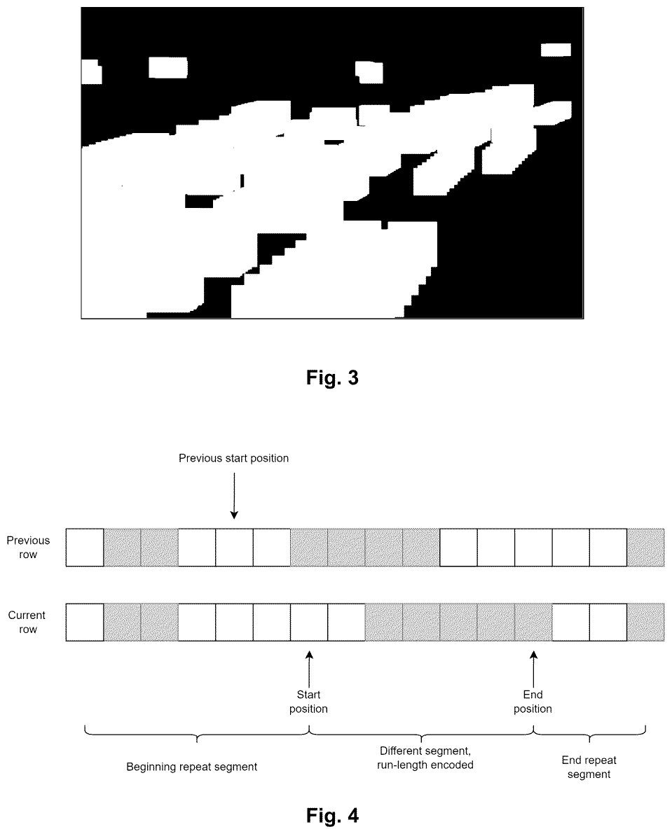

Features as described herein present an algorithm to losslessly compress binary mask images. An example of an input binary mask image is show in FIG. 3. In the figure, the white regions are considered as foreground regions (which may contain important information), and the black regions are considered as background regions. The binary mask image may be used in ROI-based technologies for video coding for machines.

Forms of binary mask image or video may include, but may not be limited to, one or more of the following: region-of-interest (ROI) mask, alpha mask (a.k.a. alpha plane), occupancy mask, filtering mask. Embodiments described herein may be applied with any form of binary mask image or video.

A region-of-interest mask may indicate one or more regions of interest in an associated image. A region of interest may be perceptually more important to human viewers or may be more important to improve a computer vision task accuracy when compared to areas outside of the regions of interest.

An alpha mask may be used to provide transparency information for an associated image. A first value of an alpha mask may represent a fully opaque pixel, and a second value may represent a fully transparent pixel.

An occupancy mask may be used in patch-based volumetric video coding to indicate which sample locations of an associated texture image (a.k.a. texture atlas) are occupied by pixel values to be used in volumetric video reconstruction and which sample locations are unoccupied, i.e., should not be used in volumetric video reconstruction. A first value of an occupancy mask may indicate an occupied sample location, and a second value may indicate an unoccupied sample location.

A filtering mask may be used to indicate the areas that are subject to filtering and/or are not subject to filtering. The type of filtering may be, but may not be limited to, one or more of the following: film grain noise synthesis, adaptive loop filtering (ALF), post-filtering. A first value of a filtering mask may indicate that no filtering is applied for the collocated pixel in an associated image, and a second value may indicate that filtering is applied for the collocated pixel in an associated image.

With features as described herein, the pixels in a binary mask may be first encoded by a 2D run length method into a list of elements, where each element consists of a number and a context. Next, the numbers in the list may be encoded into a bitstream (or stored) by an entropy encoder using a context associated with the number.

In some example embodiments, the difference of the current row and a previous row may be identified by the start position and the length of the different segment.

In some example embodiments, the difference of the start position and the previous start position, also referred to as relative position, of the different segment may be encoded/decoded to/from the bitstream.

In some example embodiments, the number of repeated rows may be encoded/decoded to/from the bitstream.

In some example embodiments, an unsigned run length context (URLC) may be used by an entropy codec to encode/decode run length numbers. A signed relative position context (SRPC) may be used by an entropy codec to encode/decode relative position numbers.

In some example embodiments, the cumulative distribution vector (CDV) may be determined by the width and/or the height of the binary mask.

In some example embodiments, one or more CDVs (or the parameters to construct the one or more CDVs) may be signaled from the encoder to the decoder.

### Encoding

The pixel value in a binary mask, where the elements are arranged in rows and columns, may be “0” or “1”.

The encoding may consist of two stages. At a first stage, an RLE with Context (RLEC) method may be used to convert a binary mask into a list of numbers and associated contexts. The numbers may be run length numbers or relative position numbers. At the second stage, the list of numbers may be encoded into a bitstream (or stored) using a context-based entropy coding.

An example of details of RLEC method is described below. RLEC may be used to encode a binary mask to a list of numbers and associated contexts. The output of this process may be provided as a list of elements, where each element consists of a number and a context identifier (ID). The number may be a run length number or a relative position number. Examples of contexts include:
an unsigned run length context (URLC), and
a signed relative position context (SRPC)

A current row is the row to be encoded using the RLEC method. A previous row is the row above the current row which has already been processed. Two rows are equal if all elements in one row are equal to the corresponding elements in the other row. In the following sections, width and height refer to the width and height of the binary mask to be encoded/decoded.

In one example method, the encoder may first initialize the following variables:
an empty output list,
a number of repeated row variable as zero,.
a previous row vector as a zero vector with the dimension of width, and
a previous start position variable as zero.

Next, the encoder may compare the current row with a previous row vector. If the current row equals to previous row vector, then the encoder may increment the value of number of repeated row variable by one (1), and continue the comparison with the next row. If all rows have been processed, the encoder may append the value of number of repeated row variable and URLC ID to the output list. The unsigned run length context (URLC) ID is the identification of the context (or more specifically the CDV) used to encode/decode the associated number. If the current row is not equal to the previous row vector, the encoder may append the value of number of repeated row variable and URLC ID to the output list, and then perform the RLEC encoding to the current row. After the current row has been encoded, the encoder may set the previous-row vector as the current row, and set the next row as the current row. This procedure may be repeated until all the rows of the mask have been encoded.

The RLEC encoding of the current row may consist of two stages. At a first stage, the encoder may detect the region, referred to as different segment, in a current row that is different than the previous row, and then encode the relative position of the start position of the current different segment with previous start position, and a length of the different segment to the output list. This stage may be performed with the following steps:
detect the first element and the last element in the current row that are different than the corresponding elements in the previous row. The position of the first element is referred to as start position of the different segment and the position of the last element is referred to as end position of the different segment,
append the difference of the start position and the previous start position (start position of the previous row), i.e., relative start position, and SRPC ID into the output list (the signed relative position context (SRPC) ID is the identification of the context (or the CDV) used to encode/decode the associated number),.
appends the difference of the end position and the start position, i.e., the length of the different segment, and URLC ID into the output list.

At the second stage, the encoder may encode the elements in the different segment into the output list. This stage may be performed with the following steps:
set a previous value variable to be the element value of the start position in the current row (the previous value variable is the variable storing the value of the previous pixel. It may be used to detect if the value of the pixel is different than the previous pixel.),
set a run length variable to one (1), and
for each element between the start position plus 1 and the end position, if the value of the element is the same as previous value variable, increase the run length variable by one (1), otherwise, append the run length variable and URLC ID to the output list, set the previous value to be the element value, and set the run length value to 1.

Referring also to FIG. 4, some example concepts described herein are illustrated. In this example, the shaded cells indicate pixels with a value of one (1), and the white or clear cells indicate pixels with a value of zero (0). The difference between a start position and a previous start position may be encoded with SRPC. The length of the different segment may be encoded with URLC. The elements in the different segment may be run length encoded with context, where the run length numbers may be associated with URLC.

The following pseudo code illustrates the RLEC encoding process of a given binary mask:

```
# given mask, width and height
output=[ ] # initialize empty output list
prev_row = zeros_vector # initialize prev_row variable as a zero-value vector with the length
of width
row_rl = 0 # initialize row run length
prev_start = 0 # initialize previous start position
for each row in mask {
  if prev_row == row {
      # same as previous row
      row_ll += 1
  } else {
      # different than the previous row
      output.append((row_ll, URLC))
      # find the start and end element in the different region w.r.t the previous row
      pix_diff = where(prev_row != row) # find different elements
      start_idx = pix_diff[0] # the first different element
      end_idx = pix_diff[−1]+1 # the last different element position plus 1
    # append the start position of the different region
    output.append((start_idx-prev_start,SRPC))
    # append the length of the different region
    output.append((end_idx-start_idx, URLC))
    prev_start = start_idx
    # encode the different region in the current row
    prev_v = row[start_idx] # initialize the previous element value
    run_length = 1 # element run length
    for each pix in row[start_idx+1:end_idx] {
      if pix == prev_v {
          run_length += 1
        } else {
          output.append((run_length, URLC))
          prev_v = pix
          run_length = 1
      }
    }
    # ending of the different region
    output.append((run_length, URLC))
    # reset previous row
    prev_row = row
    row_rl = 0
}
output.append((row_rl, URLC))
```

The described RLEC encoding generates a list of elements, where each element consists of a number and a context ID. Next, the generated list of elements may be encoded by a context-based entropy codec.

### Context-Based Entropy Codec

For each context, a probability distribution function may be predefined for the numbers to be encoded. An entropy encoder may encode each number, also referred to as symbol, according to a probability distribution associated with the context. The probability distribution of each context may be learned from a training dataset.

The probability distribution of each context may be represented by a vector, referred to as cumulative distribution vector (CDV) and an offset value, where the sum of the index of an element and the offset represents the value of the symbol to be encoded, the elements in a CDV represents the cumulative distribution value of the symbol to be encoded. The elements in the CDV may be stored in integer format and a maximum precision factor in integer may be defined. The fraction of the element value in CDV and the maximum precision factor represents the value of the accumulative probability distribution of the symbol to be encoded/decoded.

As noted above, the sum of the offset value and the index of an element is the number (value of the symbol) to be encoded. For example:
when the numbers to be encoded are 7, 8, 9 and each number is associated with a probability 0.2, 0.3, and 0.5, respectively. The system may use vector [0.2, 0.3, 0.5] as the distribution vector and the offset value may be 7. The first element in vector [0.2, 0.3, 0.5] is for the first element 7, and so on. As described herein, cumulative distribution values may be used, so the CDV may be [0.2, 0.5, 1.0].
It should also be noted that the offset may be a negative value. For example, if the offset value is −1, the same CDV may be used to encode numbers −1, 0, 1.

Given the CDVs for each context, an entropy encoder may encode the list of symbols associated with the contexts into a bitstream using arithmetic encoding or asymmetric numeral systems (ANS) method at the encoder side. The same CDVs are available at the decoder side. An entropy decoder may decode the list of symbols from the bitstreams according to the CDVs associated with the current context.

The range of a CDV may be the range of symbols that the CDV represents. For example, a CDV with the range from 0 to 32 (inclusive) contains the accumulative distribution values for numbers from 0 to 32. The CDV may be a vector with 33 elements and the offset for the CDV may be zero. The first element may be the accumulative distribution value for symbol 0, and the last element may be the accumulative distribution value for symbol 32.

A CDV may contain an out-of-range (OOR) element to represent symbols that fall out of the range of the CDV. The OOR element may be a value that is the sum of the largest number in the range of the CDV and 1. For example, the OOR element may be symbol 33 for a CDV with the range of 0 to 32. To encode a number that falls out of the range of the CDV, the encoder may first encode the OOR symbol, then encode the number or the difference of the number and the OOR symbol with one of the following methods:
a predefined binary format, for example 2 bytes unsigned integer in little-endian format,
Golomb encoding,
entropy encoding using a distribution specified by a CDV.

In one example embodiment, the range of a CDV may be the maximum value of the width and height of the binary mask. An OOR element may not be required in this case.

In some example embodiments, the range of a CDV may be proportional to the width, the height or the maximum value of the width and height of the binary mask. For example, for a binary mask with size 512×512, the range may be 32. As another example, for a binary mask with the size of 1024×1024, the range may be 64.

In some example embodiments, different contexts and CDVs may be defined for horizontal run length numbers, horizonal relative position numbers, vertical run length numbers, and vertical relative position numbers. In one example embodiment, the range of the CDV for the horizontal run length context and/or horizontal relative position context may be the width of the binary mask. The range of the CDV for the vertical run length context and/or vertical relative position context may be the height of the binary mask. In another example embodiment, the range of the CDV for the horizontal run length context and/or horizontal relative position context may be proportional to the width of the binary mask. The range of the CDV for the vertical run length context and/or vertical relative position context may be proportional to the height of the binary mask.

In one example embodiment, more than one CDV may be defined for a context, and the encoder may signal the identifier of the CDV to the decoder for a context. In another example embodiment, the encoder may signal the parameters of a CDV, for example, the type of distribution and/or the range, to the decoder.

### Decoding

At the decoder side, it may be assumed that the width and the height of the binary mask is known. The CDVs for various contexts are the same as those at the encoder side.

At an initialization stage, the decoder may start to construct a binary mask with all elements set to zero, initialize a previous row variable as a zero vector with the same dimension as the width, set a current row index variable to zero, set a previous start position variable to zero, and set an element index variable to zero.

Next, the decoder may repeat the following steps until an exist condition is met:
decode a number n from a bitstream with an entropy decoder using the CDV for URLC,
set the next n rows to be identical to the previous row, and increase the current row index by n,
if the current row index is greater than the height of the binary mask, exit the loop,
perform a decoding process (described further below) to reconstruct a row from the bitstream, and set the current row in the binary mask to be identical to the reconstructed row,
set the previous row vector to be the current row,.
increase the current row index by one (1), and.
if the current row index is greater than the height of the binary mask, exit the loop.

The decoding process to reconstruct the current row may comprise the decoder:
initializes a current row buffer as a zero vector with the dimension of the width of the binary mask,
decodes a number from the bitstream using SRPC, and assign the sum of the decoded number and the previous start position variable to the start position variable,
assigns a start position variable to the previous start position variable,
decodes a number from the bitstream using URLC, and assigns the sum of the decoded number and the start position variable to an end position variable,
copies a segment between the beginning to the element before the start position from the previous row to the current row buffer,
copies a segment between the end position to the end of the row from the previous row to the current row buffer,
sets the previous value as the value of the element at the start position of the previous row,
assigns the start position to a current position index variable (The current position index variable is the variable storing the current position. As the pixels are processed in a row one-by-one, the variable marks the current position.),
while the current position index value is less than the end position:
   decode a run length number n from the bitstream using URLC,
   assign the next n elements from the current position to the value of one (1) minus the previous value,
   set the previous value to one (1) minus the previous value, and
   increase the current position index by n.

The following pseudo code illustrates the RLEC decoding process.

```
# initialize a binary mask with the shape of height and width
rec = zeros(height, width)
# initialize the previous row as a zero vector
prev_row = zeros(width)
# initialize row index, previous start and previous end variables
row_idx = 0
prev_start = 0
v_idx = 0
while True {
      # reconstruct row
      # get repeated row run length value
  row_rl = get_symbol(URLC)
  # repeat the previous row
  for ii in range(row_rl) {
    rec[row_idx] = prev_row
    row_idx += 1
  }
  # break if all rows have been reconstructed
  if row_idx >= height: break
  # reconstruct a row buffer
      row = np.zeros(width, dtype=np.uint8)
      # start position and end position of the different segment
  start_idx = prev_start + get_symbol(SRPC)
  prev_start = start_idx
  seg_len = get_symbol(URLC)
  end_idx = start_idx + seg_len
  # repeat the beginning of the previous row
  pix_idx = start_idx
      row[:start_idx] = prev_row[:start_idx]
      # process the different segment
  prev_v = prev_row[start_idx]
  while pix_idx < end_idx {
    rl = get_symbol(URLC)
    row[pix_idx:pix_idx+rl] = 1-prev_v
    prev_v = 1 − prev_v
    pix_idx += rl
  }
  # fill row ending
  row[end_idx:] = prev_row[end_idx:]
  # set reconstructed row
  rec[row_idx] = row
  row_idx += 1
  # exit if all rows are processed
  if row_idx >= height: break
  # reset previous row
  prev_row = row
}
return rec
```

### Binary Mask Transformation

The input binary mask may be transformed before the encoding. For example, one or more of the following transforms may be applied:
Rotate clockwise 90 degrees,
Rotate clockwise 180 degrees,
Rotate clockwise 270 degrees,
Flip horizontally,
Flip vertically,
Flip horizontally and vertically,
Invert pixel values, for example, one minus the pixel values

It is to be understood that the list of transforms above is an example and embodiments may be realized with any other set of transforms, which may, but need not, include one or more of the transforms in the list of transforms above.

In an example embodiment, the transforms applied prior to encoding are indicated with a syntax element, which may be hereafter referred to as binary_mask_transform_idc.

In an example embodiment, bit position(s) of binary_mask_transform_idc and their values are pre-defined to indicate the transform(s).

In one example embodiment, a binary_mask_transform_idc syntax element may be used to indicate the transformations that has been applied to the input binary mask. In one example, binary_mask_transform_idc & 0x03 may indicate the rotation transformation. For example:
0: no rotation transformation has been applied
1: the input has been rotated 90 degrees clockwise
2: int input has been rotated 180 degrees clockwise
3: the input has been rotated 270 degrees clockwise

In one example, binary_mask_transform_idc & 0x0c may indicate the flip transformation. For example:
0: no flip transformation has been applied
1: the input has been flipped horizontally
2: the input has been flipped vertically
3: the input has been flipped horizontally and vertically

In one example, binary_mask_transform_idc & 0x10 may indicate the inverse transformation. For example:
0: no inverse transformation has been applied
1: the input has been inverted

In one type of example, the encoder may apply more than one combination of the transformations to the input binary mask, encode the transformed binary masks and select the combination of the transformations that generates the least bitstream size as the transformation mode. The selected transformation mode, and the bitstream generated with the selected model, may be transferred to the decoder.

In an example embodiment, the order of applying the transforms is pre-defined. For example, rotation may be pre-defined to be applied prior to flipping.

In an example embodiment, more than one syntax element is used to indicate the transforms. For example, a first syntax element may indicate if rotation has been applied, and if so, which option for rotation, a second syntax element may indicate if flipping has been applied, and if so, which option for flipping, and a third syntax element may indicate if mask values have been inverted. The order of applying the transforms may be pre-defined, or the order may be indicated.

In an example embodiment, the count of applied transforms is indicated with a first syntax element for each transform, its type (e.g., rotation, flipping, or inversion) is indicated with a second syntax element and further information may be provided with a third syntax element (e.g., indicative of 90, 180, or 270 degree rotation, or horizontal, vertical, or both horizontal and vertical flipping).

At the decoder side, a reconstructed binary mask and the transformation mode may be decoded from the bitstream. The reverse operation of the transformation may be performed to the decoded binary mask to generate the final output. The reverse operations of the aforementioned transformations are shown in the next table.

| Transformation | Reverse operation |
|---|---|
| Rotate 90 degrees clockwise | Rotate 90 degrees counterclockwise |
| Rotate 180 degrees clockwise | Rotate 180 degrees counterclockwise |
| Rotate 270 degrees clockwise | Rotate 270 degrees counterclockwise |
| Flip horizontally | Flip horizontally |
| Flip vertically | Flip vertically |
| Flip horizontally and vertically | Flip horizontally and vertically |
| Invert pixel values | Invert pixel values |

In accordance with one example embodiment, an apparatus may be provided comprising: at least one processor; and at least one non-transitory memory storing instructions that, when executed with the at least one processor, cause the apparatus to perform: converting a mask into a list of numbers and at least one associated context; and encoding a plurality of the list of numbers using a context-based coding based upon the at least one associated context.

The context-based coding may comprise a context-based entropy coding. The at least one associated context may comprise at least two associated contexts. The at least one associated context may comprise at least one of: an unsigned run length context, or a signed relative position context. The instructions stored in the at least one memory, when executed with the at least one processor, may be configured to cause the apparatus to perform: comparing a current row of the mask with a previous row of the mask. The instructions stored in the at least one memory, when executed with the at least one processor, may be configured to cause the apparatus to perform: determining whether the current row is equal to a row vector of the previous row. The instructions stored in the at least one memory, when executed with the at least one processor, may be configured to cause the apparatus to perform: based upon determining that the current row is equal to the row vector of the previous row, incrementing a value of a number of a repeated row variable by 1 and continuing the comparing with a next row of the mask. The instructions stored in the at least one memory, when executed with the at least one processor, may be configured to cause the apparatus to perform: determining that all rows of the mask have been processed, and appending to an output list: the value of the repeated row variable, and an associated context ID. The instructions stored in the at least one memory, when executed with the at least one processor, may be configured to cause the apparatus to perform: based upon determining that the current row is not equal to the row vector of the previous row, performing the encoding of the current row of the mask comprising use of run length encoding with context (RLEC). The instructions stored in the at least one memory, when executed with the at least one processor, may be configured to cause the apparatus to perform: appending to an output list: the value of the repeated row variable, and an unsigned run length context ID to an output list. The instructions stored in the at least one memory, when executed with the at least one processor, may be configured to cause the apparatus to perform: after the appending to the output list: setting the current row as the row vector of the previous row, and setting the next row as the current row. The instructions stored in the at least one memory, when executed with the at least one processor, may be configured to cause the apparatus to perform: detecting a segment in a current row of the mask which is different than a corresponding segment in a previous row of the mask, and encoding to an output list at least one of: a start position of the different segment, a length of the different segment, or a position of the start position of the different segment relative to a start position of the corresponding segment in the previous row. The instructions stored in the at least one memory, when executed with the at least one processor, may be configured to cause the apparatus to perform: encoding, to the output list, elements in the different segment, where the elements comprise at least one of the list of numbers and at least one of the associated contexts. The at least one associated context may comprise a respective probability distribution function. The respective probability distribution function may comprise one or more cumulative distribution vectors. The respective probability distribution function may comprise at least two different cumulative distribution vectors. The instructions stored in the at least one memory, when executed with the at least one processor, may be configured to cause the apparatus to perform: causing sending of a signal configured for a decoder to identify the at least two different cumulative distribution vectors. At least one of the cumulative distribution vectors may have a range which corresponds to a range of the numbers that the cumulative distribution vectors represents. The range may be determined with at least one of a width of the mask or a height of the mask. The range may be determined based at least partially upon a proportion related to at least one of a width of the mask or a height of the mask. The instructions stored in the at least one memory, when executed with the at least one processor, may be configured to cause the apparatus to perform: causing sending a signal to a decoder comprising the one or more cumulative distribution vectors or parameters for the decoder to construct the one or more cumulative distribution vectors. The respective probability distribution function may comprise an offset. At least one of the at least one associated context may comprise different contexts comprising cumulative distribution vectors defined for at least one of: horizontal run length numbers, horizonal relative position numbers, vertical run length numbers, or vertical relative position numbers. The instructions stored in the at least one memory, when executed with the at least one processor, may be configured to cause the apparatus to perform: mask transformation before the encoding comprising at least one of: rotating the mask clockwise 90 degrees, rotating the mask clockwise 180 degrees, rotating the mask clockwise 270 degrees, flipping the mask horizontally, flipping the mask vertically, flipping the mask horizontally and vertically, or inverting pixel values. The encoding of the plurality of the list of numbers using the context-based coding may comprise: using an entropy encoder with an unsigned run length context to encode a first portion of the mask, and using the entropy encoder with a signed relative position context to encode a different second portion of the mask.

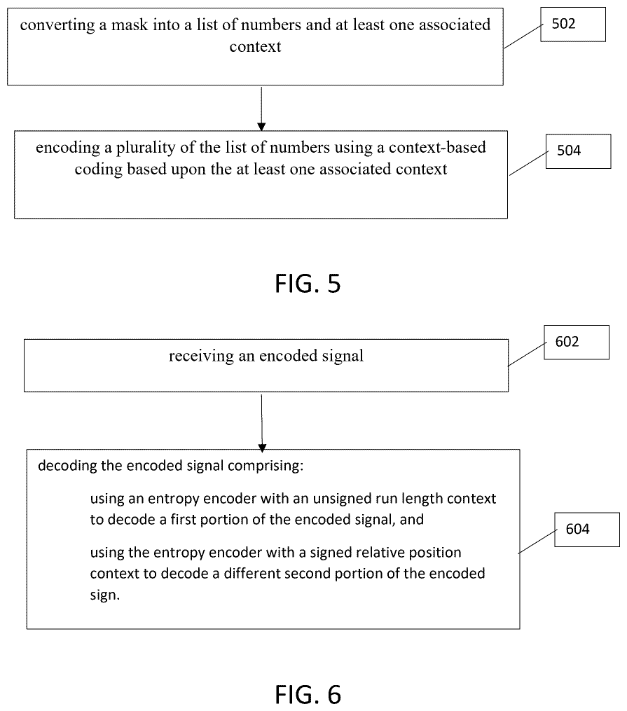

Referring also to FIG. 5, in accordance with one example embodiment, a method may be provided comprising: converting a mask into a list of numbers and at least one associated context as indicated with block 502; and encoding a plurality of the list of numbers using a context-based coding based upon the at least one associated context as indicated with block 504. The context-based coding may comprise a context-based entropy coding. The at least one associated context may comprise at least two associated contexts. The at least one associated context may comprise at least one of: an unsigned run length context, or a signed relative position context. The method may comprise comparing a current row of the mask with a previous row of the mask. The method may comprise determining whether the current row is equal to a row vector of the previous row. The method may comprise, based upon determining that the current row is equal to the row vector of the previous row, incrementing a value of a number of a repeated row variable by 1 and continuing the comparing with a next row of the mask. The method may comprise: determining that all rows of the mask have been processed, and appending to an output list: the value of the repeated row variable, and an associated context ID. The method may comprise, based upon determining that the current row is not equal to the row vector of the previous row, performing the encoding of the current row of the mask comprising use of run length encoding with context (RLEC). The method may comprise appending to an output list: the value of the repeated row variable, and an unsigned run length context ID to an output list. The method may comprise, after the appending to the output list: setting the current row as the row vector of the previous row, and setting the next row as the current row. The method may comprise: detecting a segment in a current row of the mask which is different than a corresponding segment in a previous row of the mask, and encoding to an output list at least one of: a start position of the different segment, a length of the different segment, or a position of the start position of the different segment relative to a start position of the corresponding segment in the previous row. The method may comprise encoding, to the output list, elements in the different segment, where the elements comprise at least one of the list of numbers and at least one of the associated contexts. The at least one associated context may comprise a respective probability distribution function. The respective probability distribution function may comprise one or more cumulative distribution vectors. The respective probability distribution function may comprise at least two different cumulative distribution vectors. The method may comprise causing sending of a signal configured for a decoder to identify the at least two different cumulative distribution vectors. At least one of the cumulative distribution vectors may have a range which corresponds to a range of the numbers that the cumulative distribution vectors represents. The range may be determined by at least one of a width of the mask or a height of the mask. The range may be determined based at least partially upon a proportion related to at least one of a width of the mask or a height of the mask. The method may comprise causing sending a signal to a decoder comprising the one or more cumulative distribution vectors or parameters for the decoder to construct the one or more cumulative distribution vectors. The respective probability distribution function may comprise an offset. At least one of the at least one associated context may comprise different contexts comprising cumulative distribution vectors defined for at least one of: horizontal run length numbers, horizonal relative position numbers, vertical run length numbers, or vertical relative position numbers. The method may comprise mask transformation before the encoding comprising at least one of: rotating the mask clockwise 90 degrees, rotating the mask clockwise 180 degrees, rotating the mask clockwise 270 degrees, flipping the mask horizontally, flipping the mask vertically, flipping the mask horizontally and vertically, or inverting pixel values. The encoding of the plurality of the list of numbers using the context-based coding may comprise: using an entropy encoder with an unsigned run length context to encode a first portion of the mask, and using the entropy encoder with a signed relative position context to encode a different second portion of the mask.

In accordance with one example embodiment, an apparatus is provided comprising: means for converting a mask into a list of numbers and at least one associated context; and means for encoding a plurality of the list of numbers using a context-based coding based upon the at least one associated context.

In accordance with one example embodiment, a non-transitory program storage device is provided, readable by an apparatus, tangibly embodying a program of instructions executable with the apparatus for performing operations, the operations comprising: converting a mask into a list of numbers and at least one associated context; and encoding a plurality of the list of numbers using a context-based coding based upon the at least one associated context.

In accordance with one example embodiment, an apparatus is provided comprising: at least one processor; and at least one non-transitory memory storing instructions that, when executed with the at least one processor, cause the apparatus to perform: receiving an encoded signal; and decoding the encoded signal comprising: using an entropy encoder with an unsigned run length context to decode a first portion of the encoded signal, and using the entropy encoder with a signed relative position context to decode a different second portion of the encoded sign.

The encoded signal may comprise a list of numbers, regarding a mask, encoded with a context-based coding based upon at least one context associated with the numbers. The context-based coding may comprise a context-based entropy coding. The at least one associated context may comprise at least two associated contexts. The instructions stored in the at least one memory, when executed with the at least one processor, may be configured to cause the apparatus to perform: decode a number n from the encoded signal, use the number n to set an n number of rows in a mask to be identical. The instructions stored in the at least one memory, when executed with the at least one processor, may be configured to cause the apparatus to perform: decoding a number from the encoded signal using the unsigned run length context, assigning a sum of the decoded number and a previous start position variable to a start position variable. The instructions stored in the at least one memory, when executed with the at least one processor, may be configured to cause the apparatus to perform: assigning a start position variable to the previous start position variable. The instructions stored in the at least one memory, when executed with the at least one processor, may be configured to cause the apparatus to perform: decoding a number from the bitstream using the unsigned run length context, assigning a sum of the decoded number and a start position variable to an end position variable. The instructions stored in the at least one memory, when executed with the at least one processor, may be configured to cause the apparatus to perform: copying a segment, between a beginning of an element to before a start position, from the previous row, to a current row buffer. The instructions stored in the at least one memory, when executed with the at least one processor, may be configured to cause the apparatus to perform: copying a segment, between an end position and an end of the row, from a previous row to a current row buffer. The instructions stored in the at least one memory, when executed with the at least one processor, may be configured to cause the apparatus to perform: setting a previous value as a value of an element of a start position of a previous row. The instructions stored in the at least one memory, when executed with the at least one processor, may be configured to cause the apparatus to perform: assigning a start position to a current position index variable. The instructions stored in the at least one memory, when executed with the at least one processor, may be configured to cause the apparatus to perform, while a current position index value is less than an end position of a mask: decoding a run length number n from a bitstream using the unsigned run length context, assigning a next n elements from a current position to a value of one minus a previous value, setting a previous value to one minus the previous value, and increase a current position index by n. The instructions stored in the at least one memory, when executed with the at least one processor, may be configured to cause the apparatus to perform a reconstructing of a binary mask from the decoded signal. The instructions stored in the at least one memory, when executed with the at least one processor, may be configured to cause the apparatus to perform: determining of a transformation mode from the received encoded signal, and applying a reverse operation with the decoding based upon the transformation mode. The instructions stored in the at least one memory, when executed with the at least one processor, may be configured to cause the apparatus to perform the reverse operation comprising at least one of: rotate 90 degrees counterclockwise, rotate 180 degrees counterclockwise, rotate 270 degrees counterclockwise, flip horizontally, flip vertically, flip horizontally and vertically, or invert pixel values.

Referring also to FIG. 6, in accordance with one example embodiment, a method is provided comprising: receiving an encoded signal as indicated with block 602; and, as indicated with block 604, decoding the encoded signal comprising: using an entropy encoder with an unsigned run length context to decode a first portion of the encoded signal, and using the entropy encoder with a signed relative position context to decode a different second portion of the encoded sign. The encoded signal may comprise a list of numbers, regarding a mask, encoded with a context-based coding based upon at least one context associated with the numbers. The context-based coding may comprise a context-based entropy coding. The at least one associated context may comprise at least two associated contexts. The method may comprise: decoding a number n from the encoded signal, using the number n to set an n number of rows in a mask to be identical. The method may comprise: decoding a number from the encoded signal using the unsigned run length context, assigning a sum of the decoded number and a previous start position variable to a start position variable. The method may comprise assigning a start position variable to the previous start position variable. The method may comprise: decoding a number from the bitstream using the unsigned run length context, and assigning a sum of the decoded number and a start position variable to an end position variable. The method may comprise copying a segment, between a beginning of an element to before a start position, from the previous row, to a current row buffer. The method may comprise copying a segment, between an end position and an end of the row, from a previous row to a current row buffer. The method may comprise setting a previous value as a value of an element of a start position of a previous row. The method may comprise assigning a start position to a current position index variable. The method may comprise, while a current position index value is less than an end position of a mask: decoding a run length number n from a bitstream using the unsigned run length context, assigning a next n elements from a current position to a value of one minus a previous value, setting a previous value to one minus the previous value, and increasing a current position index by n. The method may comprise causing reconstructing of a binary mask from the decoded signal. The method may comprise: determining of a transformation mode from the received encoded signal, and applying a reverse operation with the decoding based upon the transformation mode. The reverse operation may comprise at least one of: rotate 90 degrees counterclockwise, rotate 180 degrees counterclockwise, rotate 270 degrees counterclockwise, flip horizontally, flip vertically, flip horizontally and vertically, or invert pixel values.

In accordance with one example embodiment, an apparatus may be provided comprising: means for receiving an encoded signal; and means for decoding the encoded signal comprising: using an entropy encoder with an unsigned run length context to decode a first portion of the encoded signal, and using the entropy encoder with a signed relative position context to decode a different second portion of the encoded sign.

In accordance with one example embodiment, a non-transitory program storage device may be provided, readable by an apparatus, tangibly embodying a program of instructions executable with the apparatus for performing operations, the operations comprising: receiving an encoded signal; and decoding the encoded signal comprising: using an entropy encoder with an unsigned run length context to decode a first portion of the encoded signal, and using the entropy encoder with a signed relative position context to decode a different second portion of the encoded sign.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising: at least one processor; and at least one memory storing instructions that, when executed by the at least one processor, cause the apparatus at least to perform: converting a mask into a list of numbers and at least one associated context; and encoding a plurality of the list of numbers using a context-based coding based upon the at least one associated context.

2. The apparatus according to claim 1, wherein the at least one associated context comprises at least one of: an unsigned run length context; or a signed relative position context.

3. The apparatus according to claim 1, wherein the instructions stored in the at least one memory, when executed by the at least one processor, further cause the apparatus to perform: comparing a current row of the mask with a previous row of the mask; and determining whether the current row is equal to a row vector of the previous row.

4. The apparatus according to claim 3, wherein the instructions stored in the at least one memory, when executed by the at least one processor, further cause the apparatus to perform: based upon determining that the current row is equal to the row vector of the previous row, incrementing a value of a number of a repeated row variable by 1 and continuing the comparing with a next row of the mask.

5. The apparatus as claimed in claim 4, wherein the instructions stored in the at least one memory, when executed by the at least one processor, further cause the apparatus to perform: determining that all rows of the mask have been processed, and appending to an output list: the value of the repeated row variable, and an associated context identifier.

6. The apparatus according to claim 3, wherein the instructions stored in the at least one memory, when executed by the at least one processor, further cause the apparatus to perform: based upon determining that the current row is not equal to the row vector of the previous row, performing the encoding of the current row of the mask comprising use of run length encoding with context; appending to an output list: a value of a repeated row variable, and an unsigned run length context identifier; setting the current row as the row vector of the previous row; and setting a next row as the current row.

7. The apparatus according to claim 1, wherein the instructions stored in the at least one memory, when executed by the at least one processor, further cause the apparatus to perform: detecting a different segment in a current row of the mask which is different than a corresponding segment in a previous row of the mask; and encoding to an output list at least one of: a start position of the different segment, a length of the different segment, or a position of the start position of the different segment relative to a start position of the corresponding segment in the previous row.

8. The apparatus according to claim 7, wherein the instructions stored in the at least one memory, when executed by the at least one processor, further cause the apparatus to perform: encoding, to the output list, elements in the different segment, wherein the elements comprise at least one of the numbers and at least one of the associated context.

9. The apparatus according to claim 1, wherein the instructions stored in the at least one memory, when executed by the at least one processor, further cause the apparatus to perform: mask transformation before the encoding comprising at least one of: rotating the mask clockwise 90 degrees; rotating the mask clockwise 180 degrees; rotating the mask clockwise 270 degrees; flipping the mask horizontally; flipping the mask vertically; flipping the mask horizontally and vertically; or inverting pixel values.

10. The apparatus according to claim 1, wherein the encoding of the plurality of the list of numbers using the context-based coding comprises: using an entropy encoder with an unsigned run length context to encode a first portion of the mask; and using the entropy encoder with a signed relative position context to encode a different second portion of the mask.

11. A method comprising: converting a mask into a list of numbers and at least one associated context; and encoding a plurality of the list of numbers using a context-based coding based upon the at least one associated context.

12. An apparatus comprising: at least one processor; and at least one memory storing instructions that, when executed by the at least one processor, cause the apparatus at least to perform: receiving an encoded signal; and decoding the encoded signal comprising: using an entropy decoder with an unsigned run length context to decode a first portion of the encoded signal, and using the entropy decoder with a signed relative position context to decode a different second portion of the encoded signal.

13. The apparatus according to claim 12, wherein the encoded signal comprises a list of numbers, associated with a mask and encoded with a context-based coding based upon at least one context associated with the numbers.

14. The apparatus according to claim 13, wherein the instructions stored in the at least one memory, when executed by the at least one processor, further cause the apparatus to perform: decoding a first number n from the encoded signal; and using the first number n to set an n number of rows in the mask to be identical; decoding a second number from the encoded signal using the unsigned run length context, and assigning a sum of the decoded second number and a previous start position variable to a start position variable; assigning the start position variable to the previous start position variable; decoding a third number from the encoded signal using the unsigned run length context, and assigning a sum of the decoded third number and the start position variable to an end position variable; copying a segment between the beginning to an element before a start position from a previous row, to a current row buffer; copying a segment between end position and end of a row from the previous row to the current row buffer; setting a previous value as the value of the element of the start position of the previous row; assigning a start position index to a current position index variable; while the current position index value is less than the end position of the mask: decoding a run length number m from the encoded signal using the unsigned run length context; assigning next m elements from a current position to a value of one minus the previous value; setting the previous value to one minus the previous value; increasing the current position index value by m; and reconstructing the mask from the encoded signal.

15. The apparatus according to claim 12, wherein the instructions stored in the at least one memory, when executed by the at least one processor, further cause the apparatus to perform: determining of a transformation mode from the received encoded signal; and applying a reverse operation with the decoding based upon the transformation mode.

16. The apparatus according to claim 15, wherein the instructions stored in the at least one memory, when executed by the at least one processor, cause the apparatus to perform the reverse operation comprising at least one of: rotate 90 degrees counterclockwise; rotate 180 degrees counterclockwise; rotate 270 degrees counterclockwise; flip horizontally; flip vertically; flip horizontally and vertically; or invert pixel values.

17. A method comprising: receiving an encoded signal; and decoding the encoded signal comprising: using an entropy encoder with an unsigned run length context to decode a first portion of the encoded signal; and using the entropy encoder with a signed relative position context to decode a different second portion of the encoded signal.

18. The method according to claim 17, wherein the encoded signal comprises a list of numbers, regarding a mask, encoded with a context-based coding based upon at least one context associated with the numbers.

19. The method according to claim 18, further comprising: decoding a first number n from the encoded signal; and using the first number n to set an n number of rows in the mask to be identical; decoding a second number from the encoded signal using the unsigned run length context, and assigning a sum of the decoded second number and a previous start position variable to a start position variable; assigning the start position variable to the previous start position variable; decoding a third number from the encoded signal using the unsigned run length context, and assigning a sum of the decoded third number and the start position variable to an end position variable; copying a segment between the beginning to an element before a start position from a previous row, to a current row buffer; copying a segment between end position and end of a row from the previous row to the current row buffer; setting a previous value as the value of the element of the start position of the previous row; assigning a start position index to a current position index variable; while the current position index value is less than the end position of the mask: decoding a run length number m from the encoded signal using the unsigned run length context; assigning next m elements from a current position to a value of one minus the previous value; setting the previous value to one minus the previous value; increasing the current position index value by m; and reconstructing the mask from the encoded signal.

20. The method according to claim 17 comprising: determining of a transformation mode from the received encoded signal; and applying a reverse operation with the decoding based upon the transformation mode.
